(19) United States
(12) Patent Application Publication
(10) Pub. No.: US 2024/0085317 A1
(43) Pub. Date: Mar. 14, 2024

(54) IMAGE PROCESSING APPARATUS AND IMAGE PROCESSING METHOD

(71) Applicant: SONY GROUP CORPORATION, TOKYO (JP)

(72) Inventor: YIWEN ZHU, TOKYO (JP)

(21) Appl. No.: 18/262,877

(22) PCT Filed: Jan. 5, 2022
(86) PCT No.: PCT/JP2022/000081

§ 371 Date: Jul. 25, 2023

(30) Foreign Application Priority Data
Feb. 3, 2021 (JP) 2021-015748

(51) Int. Cl. G01N 21/35; G06T 7/20; G06V 10/44; G06V 10/60; H04N 23/11

(52) U.S. Cl. CPC G01N 21/35; G06T 7/20; G06V 10/44; G06V 10/60; H04N 23/11; G06T 2207/10024; G06T 2207/10048

(57) ABSTRACT

An image processing apparatus (100) includes: an image estimation unit (124) that estimates a removal image obtained by removing, from a visible image, a scatter component of sunlight scattered when passing through an atmospheric layer, on the basis of the visible image and an infrared image captured simultaneously with the visible image.

### FIELD

The present disclosure relates to an image processing apparatus and an image processing method.

### BACKGROUND

Conventionally, various image correction techniques using a technique “Dark Channel Prior” have been proposed for the purpose of improving visibility of an image reduced by scattering of natural light or the like due to fine particles of fog (mist) or haze (also referred to as “haze”) present between a camera and a subject. The “Dark Channel Prior (hereinafter, referred to as “dark channel prior”)” is a technique for estimating and restoring an image (hereinafter, referred to as a “dehazed image”) from which an influence of a scatter component has been removed, from an image the visibility of which is reduced due to scattering of natural light caused by haze.

### CITATION LIST

### Patent Literature

Patent Literature 1: JP 5954418 B2

Patent Literature 2: JP 2015-103001 A

Patent Literature 3: JP 2013-58202 A

Patent Literature 4: JP 2014-232938 A

### Non Patent Literature

Non Patent Literature 1: Kaiming He, Jian Sun, Xiaoou Tang, “Single Image Haze Removal Using Dark Channel Prior,” Computer Vision and Pattern Recognition, 2009. CVPR 2009. IEEE Conference on, pp.1956-1963, 2009

### SUMMARY

### Technical Problem

However, in the conventional technique using the dark channel prior method, the visibility of the image may not be sufficiently improved depending on the configuration of the subject. For example, in a case where a white or light gray region is included in the subject, the corresponding region is erroneously processed as a position of atmospheric scattered light (scatter component of light generated when sunlight hits fine particles of fog, haze, or the like (haze) in the atmosphere), which is a scatter component of sunlight, and as a result, estimation accuracy of transmittance of light decreases. For this reason, there is a case where a dehazed clear image cannot be restored by the conventional technique using the dark channel prior method.

Therefore, the present disclosure proposes an image processing apparatus and an image processing method capable of obtaining a clear dehazed image without being affected by the configuration of the subject.

### Solution to Problem

To solve the problems described above, an image processing apparatus according to an embodiment of the present disclosure includes: an image estimation unit that estimates a removal image obtained by removing, from a visible image, a scatter component of sunlight scattered when passing through an atmospheric layer, on a basis of the visible image and an infrared image captured simultaneously with the visible image.

### BRIEF DESCRIPTION OF DRAWINGS

FIG. 1 is a diagram illustrating an example of an image and a transmittance map used for processing of dark channel prior.

FIG. 2 is a diagram illustrating an outline of processing of an image processing apparatus according to a first embodiment of the present disclosure.

FIG. 3 is an explanatory diagram for describing the processing of the image processing apparatus according to the first embodiment of the present disclosure.

FIG. 4 is a block diagram illustrating a configuration example of the image processing apparatus according to the first embodiment of the present disclosure.

FIG. 5 is an explanatory diagram for describing a specific example of a control unit according to the first embodiment of the present disclosure.

FIG. 6 is a flowchart illustrating an example of a processing procedure of the image processing apparatus according to the first embodiment of the present disclosure.

FIG. 7 is a diagram for describing an outline of processing of an image processing apparatus according to a second embodiment of the present disclosure.

FIG. 8 is a block diagram illustrating a configuration example of the image processing apparatus according to the second embodiment of the present disclosure.

FIG. 9 is an explanatory diagram for describing a specific example of a control unit according to the second embodiment of the present disclosure.

FIG. 10 is a flowchart illustrating an example of a processing procedure of the image processing apparatus according to the second embodiment of the present disclosure.

FIG. 11 is a block diagram illustrating a configuration example of an image processing apparatus according to a third embodiment of the present disclosure.

FIG. 12 is a diagram illustrating an outline of processing according to the third embodiment of the present disclosure.

FIG. 13 is a hardware configuration diagram illustrating an example of a computer that achieves functions of the image processing apparatus according to each embodiment of the present disclosure.

### DESCRIPTION OF EMBODIMENTS

Each embodiment of the present disclosure will be described below in detail on the basis of the drawings. Note that, in each embodiment described below, components having substantially the same functional configuration may be denoted by the same number or reference numeral, and redundant description may be omitted. Further, in the present specification and the drawings, a plurality of components having substantially the same functional configuration may be distinguished and described by attaching different numbers or reference numerals after the same number or reference numeral.

Further, the present disclosure will be described according to the item order described below.
1. Introduction
1-1. Background
1-2. Regarding Dark Channel Prior
2. First Embodiment
2-1. Outline of Processing
2-2. Apparatus Configuration Example
2-3. Processing Procedure Example
3. Second Embodiment
3-1. Outline of Processing
3-2. Apparatus Configuration Example
3-3. Processing Procedure Example
4. Third Embodiment
4-1. Apparatus Configuration Example
4-2. Outline of Processing
5. Others
6. Hardware Configuration Example
7. Conclusion

### 1. INTRODUCTION

### 1-1. Background

With an increase in demand for capturing images regardless of day and night, an RGB-IR image sensor capable of simultaneously capturing an RGB image (visible image) and an infrared rays (IR) image (infrared image) has been developed and put into practical use. In the present disclosure, an IR image acquired by an RGB-IR image sensor is not used for a conventional purpose of “viewing”, but is used for improving dehazing accuracy of an RGB image the visibility of which is reduced due to haze such as fog or mist. Note that, in the following description, an infrared image or a near-infrared image may be simply referred to as an “infrared image”.

### 1-2. Regarding Dark Channel Prior

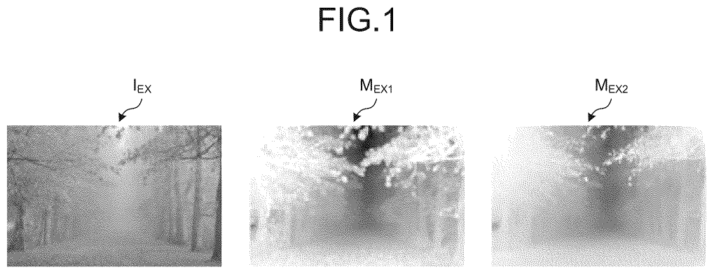

Conventionally, a method called “Dark Channel Prior (dark channel prior)” is often used as an image processing technique for removing haze from an RGB image. FIG. 1 is a diagram illustrating an example of an image and a transmittance map used for processing of dark channel prior.

The dark channel prior method is based on the statistical empirical rule that many of outdoor images indicate a very small value for the intensity value of any of the R, G and B color channels in at least one pixel constituting a local region (for example, 15×15 pixels). From this empirical rule, in the dark channel prior method, the minimum value of the color channel of each pixel constituting each local region of an input image is treated as indicating the magnitude of the degree of influence of the haze in each local region, and processing is performed to cancel the degree of influence of the haze, thereby removing the haze from the input image. That is, in the dark channel prior method, it is assumed that the intensity value of at least one pixel constituting a local region of an RGB image obtained by capturing a subject in nature is very small, and the transmittance of the RGB image is estimated by regarding the darkest pixel value (“Dark Channel”; hereinafter referred to as “dark channel”) among color channels of each local region of the RGB image as an inverted value of the transmittance of haze. Hereinafter, the dark channel prior method will be described.

First, in the dark channel prior method, a map of the dark channel of an input image (see an image I_{EX} in FIG. 1) is generated by Formula (1) described below. “J^{dark}(x)” in Formula (1) represents a dark channel. Further, “I^{c}(y)” in Formula (1) represents a pixel value of the input image. Further, “Ω(x)” in Formula (1) represents a local region (rectangular block of n×n pixels (for example, n=15 or n=9)) centered on a pixel x.

$${J}^{dark} ( x ) = {min}_{c ∈ \{ r , g , b \}} \{ {min}_{y ∈ Ω ( x )} {I}^{c} ( y ) \} \qquad ( 1 )$$

Subsequently, in the dark channel prior method, the RGB values of the brightest (top 0.1%) pixel in the dark channel of the entire image (in the map of the dark channel) are acquired as atmospheric scattered light A that is a scatter component of sunlight scattered by haze when passing through an atmospheric layer. The atmospheric scattered light A can also be rephrased as a scatter component of light generated when sunlight hits fine particles of fog, haze, or the like (haze) in the atmosphere.

Subsequently, in the dark channel prior method, a transmittance map t(x) is estimated by Formula (2) described below using the atmospheric scattered light A (see a map M_{EX1} in FIG. 1).

$$t ( x ) = 1 - {min}_{y ∈ Ω ( x )} \{ {min}_{c ∈ \{ r , g , b \}} \frac{{I}^{c} ( y )}{{A}^{c} ( y )} \} \qquad ( 2 )$$

Subsequently, in the dark channel prior method, the transmittance map t(x) is corrected by “Soft Matting”.

Then, in the dark channel prior method, a dehazed image J(x) is estimated by Formula (3) described below using the corrected transmittance map t(x) (see a map M_{EX2} in FIG. 1). “ε” in Formula (3) is a safety factor for preventing division by zero.

$$J ( x ) = \frac{I ( x ) - A}{max \{ t ( x ) , ε \}} + A \qquad ( 3 )$$

By the way, in the dark channel prior method, the dark channel, which is the darkest pixel value among the color channels in each local region of the RGB image, is regarded as the inverted value of the transmittance of light. That is, since it is assumed that “white” does not exist in a subject in nature, in a case where the input image includes a white or light gray region, there is a case where the value of the atmospheric scattered light A described above does not reflect the actual subject, and there is a problem that the estimation accuracy of the transmittance decreases. Further, since the above-described transmittance map t(x) is corrected by “Soft Matting” by using, as a guide, an image having resolution information missing due to haze, there is also a problem that the accuracy of correction is not sufficient.

The present disclosure proposes an image processing apparatus and an image processing method capable of obtaining a clear dehazed image without being affected by the configuration of a subject in view of the above-described problems of the dark channel prior method.

### 2. FIRST EMBODIMENT

### 2-1. Outline of Processing

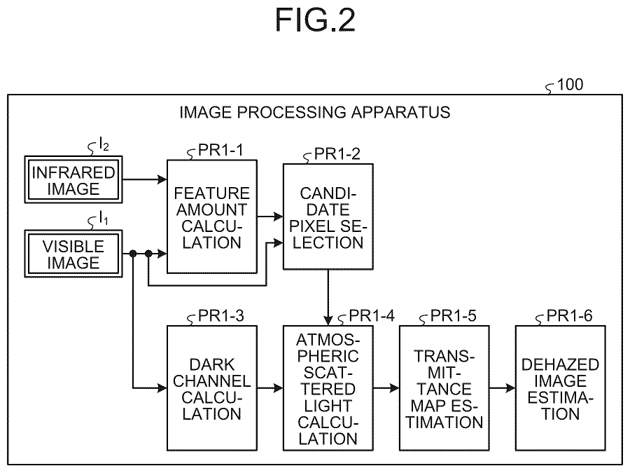

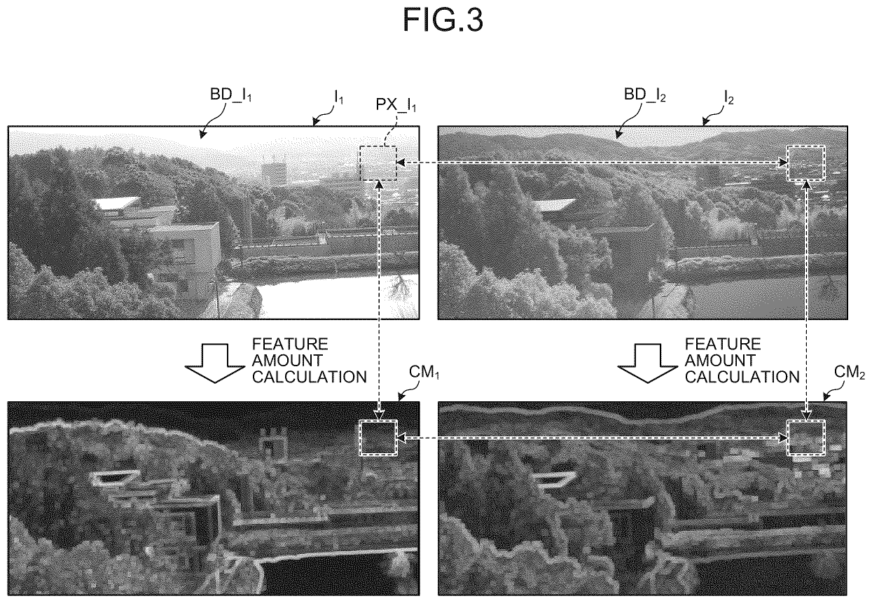

An outline of processing of the image processing apparatus according to the first embodiment of the present disclosure will be described with reference to FIGS. 2 and 3. FIG. 2 is a diagram illustrating an outline of processing of the image processing apparatus according to the first embodiment of the present disclosure. FIG. 3 is an explanatory diagram for describing the processing of the image processing apparatus according to the first embodiment of the present disclosure.

An image processing apparatus 100 illustrated in FIG. 2 acquires a visible image I₁ and an infrared image I₂. As illustrated in FIG. 3, the infrared image I₂ is obtained by simultaneously capturing a subject shown in the visible image I₁ in the same composition as the visible image I₁. The visible image I₁ is, for example, an RGB image acquired by an imaging unit equipped with an RGB-IR image sensor. The infrared image I₂ is, for example, an IR image or a near-infrared rays (NIR) image (near-infrared image) acquired by the imaging unit equipped with the RGB-IR image sensor. As illustrated in FIG. 3, in the visible image I₁, a boundary BD_I₁ between the sky and the mountain is unclear due to haze, but in the infrared image I₂ captured simultaneously, a boundary BD_I₂ between the sky and the mountain is clearly shown.

Further, the image processing apparatus 100 calculates a first feature amount indicating the contrast of the visible image I₁ for each local region of the visible image I₁ and a second feature amount indicating the contrast of the infrared image I₂ for each local region of the infrared image I₂ (procedure PR1-1). As illustrated in FIG. 3, the image processing apparatus 100 generates a contrast map CM₁ from the first feature amount of the visible image I₁ and generates a contrast map CM₂ from the second feature amount of the infrared image I₂. According to the contrast map CM₁ and the contrast map CM₂ illustrated in FIG. 3, the contrast is low in the white roof and the sky portion blurred by haze.

Further, the image processing apparatus 100 selects, from the visible image I₁, a pixel having a certain or more difference between the first feature amount and the second feature amount as a candidate pixel to be used for calculation of atmospheric scattered light (a value corresponding to the atmospheric scattered light A described above) (procedure PR1-2). Specifically, the image processing apparatus 100 selects, as a candidate pixel, a pixel among the pixels of the visible image I₁ the first feature amount of which is less than a preset first threshold value and the second feature amount of which exceeds a preset second threshold value in the infrared image I₂. That is, the image processing apparatus 100 refers to the contrast map CM₁ and the contrast map CM₂, and selects a pixel PX_I₁ having a low contrast in the visible image I₁ but a high contrast in the infrared image I₂ as a candidate pixel to be used for calculation of atmospheric scattered light. Thus, it is possible to select an optimal pixel for deriving atmospheric scattered light.

Further, the image processing apparatus 100 obtains a dark channel of the visible image I₁ and generates a map of the dark channel (procedure PR1-3). The method of calculating the dark channel is similar to the method described above.

Further, the image processing apparatus 100 calculates atmospheric scattered light on the basis of the candidate pixel selected in procedure PR1-2 and the map of the dark channel calculated in procedure PR1-3 (procedure PR1-4). Specifically, the image processing apparatus 100 derives, as atmospheric scattered light, RGB values of a pixel also corresponding to pixels having a higher brightness value (for example, the brightest top 0.1% pixels) in the dark channel of the visible image I₁ among the selected candidate pixels. Conventional dark channels can include a pixel value obtained by erroneously processing a white or light gray region in the subject as the position of the atmospheric scattered light A. On the other hand, the image processing apparatus 100 can exclude a pixel erroneously estimated as the atmospheric scattered light from the pixels included in the dark channel by setting the pixel value of the pixel corresponding to the dark channel and corresponding to the candidate pixel as the atmospheric scattered light.

Further, the image processing apparatus 100 estimates a transmittance map indicating the degree of scattering of sunlight in the visible image I₁ using the atmospheric scattered light calculated in procedure PR1-4 (procedure PR1-5). The method of calculating the transmittance map is similar to the method described above.

Further, the image processing apparatus 100 estimates a dehazed image obtained by removing the haze from the visible image I₁ using the transmittance map estimated in procedure PR1-5 (procedure PR1-6). The method of calculating the dehazed image is similar to the method described above.

### 2-2. Apparatus Configuration Example

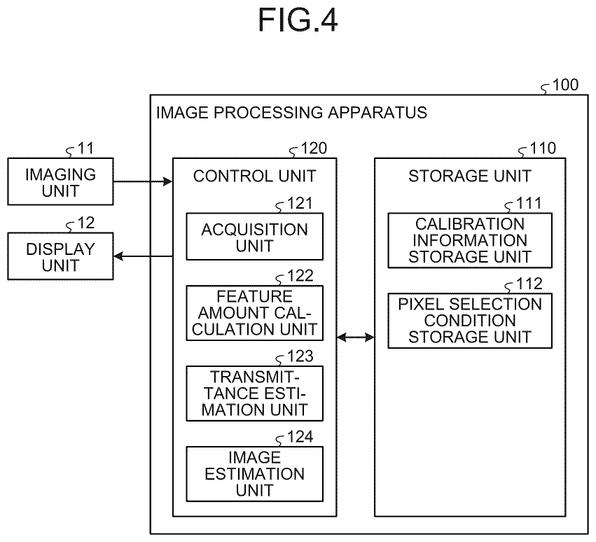

FIG. 4 is a block diagram illustrating a configuration example of the image processing apparatus according to the first embodiment of the present disclosure. The image processing apparatus 100 is connected to an imaging unit 11 and a display unit 12 via an input/output interface (illustration omitted). Further, the image processing apparatus 100 includes a storage unit 110 and a control unit 120.

The storage unit 110 is achieved by, for example, a semiconductor memory element such as random access memory (RAM) or flash memory, or a storage apparatus such as a hard disk or an optical disk. The storage unit 110 can store, for example, programs, data, and the like for achieving various processing functions executed by the control unit 120. The program stored in the storage unit 110 includes a program for achieving a processing function corresponding to each unit of the control unit 120. The program stored in a storage unit 131 includes an operating system (OS) and various application programs.

The storage unit 110 includes a calibration information storage unit 111 and a pixel selection condition storage unit 112.

The calibration information storage unit 111 stores calibration information for calibrating and aligning the visible image I₁ and the infrared image I₂ acquired by the imaging unit 11 in advance.

The pixel selection condition storage unit 112 stores a selection condition for selecting, from the visible image I₁, a candidate pixel to be used for calculation of atmospheric scattered light by a transmittance estimation unit 123 described below. As the selection condition for selecting the candidate pixel from the visible image I₁, for example, a condition that the first feature amount indicating the contrast of the visible image I₁ is less than the first threshold value and the second feature amount indicating the contrast in the infrared image I₂ exceeds the second threshold value can be defined. Note that, as a condition for selecting a candidate pixel from the visible image I₁, any condition may be defined as long as a pixel satisfying the condition that the contrast is low in the visible image I₁ but the contrast is high in the infrared image I₂ can be selected from the visible image I₁. For example, a condition that a difference between the first feature amount and the second feature amount exceeds a preset threshold value may be set.

The control unit 120 is achieved by a control circuit including a processor and a memory. The various processing executed by the control unit 120 is achieved, for example, by executing a command described in a program read from an internal memory by the processor using the internal memory as a work area. The program read from the internal memory by the processor includes an operating system (OS) and an application program. Further, the control unit 120 may be achieved by, for example, an integrated circuit such as an application specific integrated circuit (ASIC) or a field-programmable gate array (FPGA).

Further, a main storage apparatus and an auxiliary storage apparatus functioning as the internal memory described above are achieved by, for example, a semiconductor memory element such as random access memory (RAM) or flash memory, or a storage apparatus such as a hard disk or an optical disk.

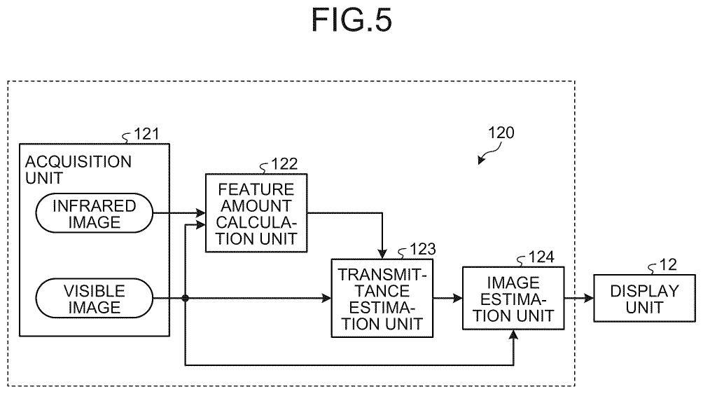

As illustrated in FIG. 4, the control unit 120 includes an acquisition unit 121, a feature amount calculation unit 122, the transmittance estimation unit 123, and an image estimation unit 124. The control unit 120 achieves processing for obtaining a clear dehazed image without being affected by the configuration of the subject. Hereinafter, a specific example of the control unit 120 will be described with reference to FIG. 5. FIG. 5 is an explanatory diagram for describing a specific example of the control unit according to the first embodiment of the present disclosure.

As illustrated in FIG. 5, the acquisition unit 121 acquires the visible image I₁ and the infrared image I₂ from the imaging unit 11. The acquisition unit 121 passes the acquired visible image I₁ and infrared image I₂ to the feature amount calculation unit 122, the transmittance estimation unit 123, and the image estimation unit 124. The imaging unit 11 corresponds to a camera module or the like equipped with an RGB-IR image sensor.

The feature amount calculation unit 122 calculates the first feature amount indicating the contrast of the visible image I₁ for each local region of the visible image I₁ and the second feature amount indicating the contrast of the infrared image I₂ for each local region of the infrared image I₂.

The feature amount calculation unit 122 can calculate the first feature amount using a component value of the R channel, the G channel, or the B channel included in the visible image I₁. Note that, when calculating the first feature amount, the feature amount calculation unit 122 preferably calculates the first feature amount by using the component value of the R channel having a wavelength close to an infrared region among the color channels included in the visible image I₁. This is because, since the infrared image I₂ captured by the image processing apparatus 100 using infrared rays (near-infrared rays) is used, with the R channel close to a wavelength of infrared rays (near-infrared rays) among the color channels included in the visible light, characteristics such as reflectance and absorptivity of light by an object are closer to infrared rays (near-infrared rays), and it is easy to compare feature amounts such as brightness values. Further, the feature amount calculation unit 122 may calculate the first feature amount by using any one of the component values of the R channel, the G channel, or the B channel included in the visible image I₁. Further, the feature amount calculation unit 122 may calculate the first feature amount by using an average value of the component values of the R channel, the G channel, and the B channel included in the visible image I₁.

Further, it is sufficient if the feature amounts calculated by the feature amount calculation unit 122 are information with which it is possible to evaluate the contrast of the local region of the visible image I₁ or the infrared image I₂. For example, the feature amount calculation unit 122 can use the dynamic range of the local region and variance of the pixel value of the local region as the feature amount. In a case where the dynamic range is used as the feature amount, the feature amount calculation unit 122 can calculate the dynamic range of each local region of the visible image I₁ using Formula (4) described below. Similarly, the feature amount calculation unit 122 can calculate the dynamic range of each local region of the infrared image I₂ using Formula (5) described below.

$${dr}_{vis} ( x ) = {max}_{y ∈ Ω ( x )} \{ {I}_{VIS}^{R} ( y ) \} - {min}_{y ∈ Ω ( x )} \{ {I}_{VIS}^{R} ( y ) \} \qquad ( 4 )$$

$${dr}_{NIR} ( x ) = {max}_{y ∈ Ω ( x )} \{ {I}_{NIR} ( y ) \} - {min}_{y ∈ Ω ( x )} \{ {I}_{NIR} ( y ) \} \qquad ( 5 )$$

“dr” in Formulae (4) and (5) described above represents a dynamic range. Further, “Ω(x)” in Formulae (4) and (5) described above represents a local region (rectangular block of n×n pixels) centered on a pixel x. The feature amount calculation unit 122 refers to the calibration information stored in the calibration information storage unit 111, and calibrates the visible image I₁ and the infrared image I₂ in advance as necessary, thereby aligning the visible image I₁ and the infrared image I₂. The feature amount calculation unit 122 passes the calculated first feature amount and second feature amount to the transmittance estimation unit 123.

Further, the transmittance estimation unit 123 selects, from the visible image I₁, a pixel having a predetermined or more significant difference between the first feature amount and the second feature amount as a candidate pixel to be used for calculation of atmospheric scattered light. Specifically, the transmittance estimation unit 123 refers to the selection condition stored in the pixel selection condition storage unit 112 and selects, as a candidate pixel, a pixel among the pixels of the visible image I₁ the first feature amount of which is less than the preset first threshold value and the second feature amount of which exceeds the preset second threshold value in the infrared image. The selection condition of the candidate pixel is expressed by Formula (6) described below. Note that “drᵥᵢₛ(x)” in Formula (6) described below represents the dynamic range of the visible image I₁. Further, “dr_{NIR}(x)” in Formula (6) described below represents the dynamic range of the infrared image I₂. “th1” and “th2” represent the first threshold value and the second threshold value, respectively.

drᵥᵢₛ(x)<th1 && dr_{NIR}(x)>th2 (6)

The transmittance estimation unit 123 obtains a dark channel of the visible image I₁ and generates a map of the dark channel by using Formula (7) described below. Note that Formula (7) described below is the same formula as Formula (1) described above although the variable I_{vic}(y) indicating the input image (visible image I₁) is different.

$${J}^{dark} ( x ) = {min}_{c ∈ \{ r , g , b \}} \{ {min}_{y ∈ Ω ( x )} {I}_{VIS}^{C} ( y ) \} \qquad ( 7 )$$

Further, the transmittance estimation unit 123 derives, as atmospheric scattered light, RGB values of a pixel also corresponding to pixels having a higher brightness value (for example, the top 0.1% brightest pixels) in the dark channel of the visible image I₁ among the candidate pixels selected from the visible image I₁. Further, the transmittance estimation unit 123 estimates a transmittance map indicating the degree of scattering of sunlight in the visible image I₁ using the atmospheric scattered light. The transmittance estimation unit 123 estimates the transmittance map using Formula (8) described below. Note that Formula (8) described below is the same formula as Formula (2) described above although the variable I_{vic}(y) indicating the input image (visible image I₁) is different. The transmittance estimation unit 123 passes the estimated transmittance map to the image estimation unit 124.

$$t ( x ) = 1 - {min}_{y ∈ Ω ( x )} \{ {min}_{c ∈ \{ r , g , b \}} \frac{{I}_{VIS}^{C} ( y )}{{A}^{c} ( y )} \} \qquad ( 8 )$$

The image estimation unit 124 estimates a dehazed image obtained by removing the haze from the visible image I₁ using the transmittance map. The image estimation unit 124 estimates the dehazed image using Formula (9) described below. Note that Formula (9) described below is the same formula as Formula (3) described above although the variable I_{vic}(x) indicating the input image (visible image I₁) is different. The image estimation unit 124 outputs the dehazed image to the display unit 12. The display unit 12 is achieved by, for example, a liquid crystal display (LCD), an organic electroluminescence display (OELD), or the like.

$$J ( x ) = \frac{{I}_{VIS} ( x ) - A}{max \{ t ( x ) , ε \}} + A \qquad ( 9 )$$

### 2-3. Processing Procedure Example

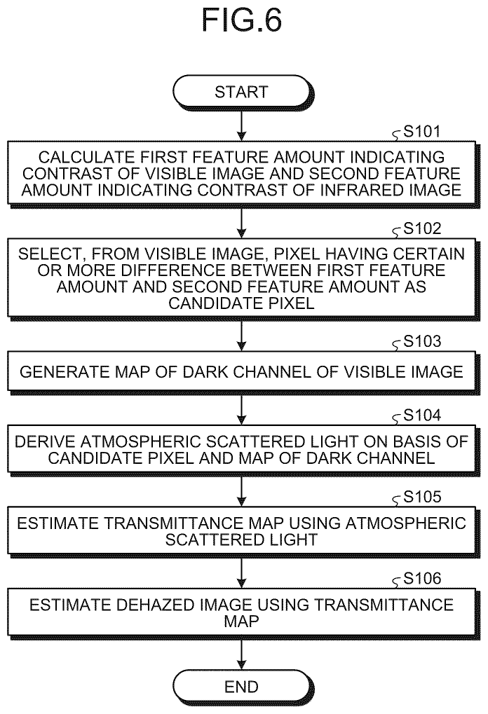

FIG. 6 is a flowchart illustrating an example of a processing procedure of the image processing apparatus according to the first embodiment of the present disclosure. The processing procedure illustrated in FIG. 6 is executed by the control unit 120 of the image processing apparatus 100.

As illustrated in FIG. 6, the feature amount calculation unit 122 calculates the first feature amount indicating the contrast of the visible image I₁ for each local region of the visible image I₁ and the second feature amount indicating the contrast of the infrared image I₂ for each local region of the infrared image I₂ (Step S101).

The transmittance estimation unit 123 selects, from the visible image I₁, a pixel having a certain or more difference between the first feature amount and the second feature amount as a candidate pixel to be used for calculation of atmospheric scattered light (Step S102).

Further, the transmittance estimation unit 123 generates a map of the dark channel of the visible image I₁ (Step S103).

Further, the transmittance estimation unit 123 derives atmospheric scattered light on the basis of the candidate pixel and the map of the dark channel (Step S104).

Further, the transmittance estimation unit 123 estimates the transmittance map using the atmospheric scattered light (Step S105).

The image estimation unit 124 estimates a dehazed image obtained by removing the haze from the visible image I₁ using the transmittance map (Step S106) and ends the processing procedure illustrated in FIG. 6.

### 3. SECOND EMBODIMENT

### 3-1. Outline of Processing

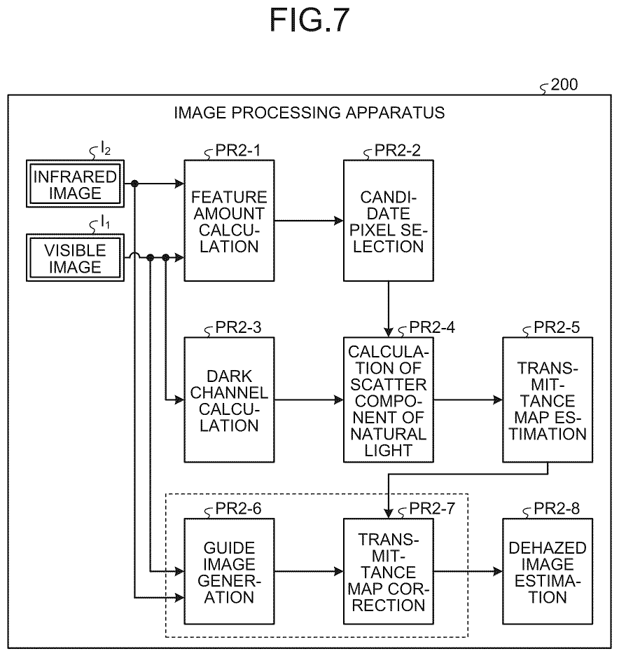

An outline of processing of the image processing apparatus according to the second embodiment of the present disclosure will be described with reference to FIG. 7. FIG. 7 is a diagram illustrating an outline of processing of the image processing apparatus according to the second embodiment of the present disclosure. An image processing apparatus 200 according to the second embodiment is different from that of the first embodiment in that the processing of a portion surrounded by the dotted line illustrated in FIG. 7 is executed. That is, procedures PR2-1 to PR2-5 and PR2-8 illustrated in FIG. 7 correspond to the procedures PR1-1 to PR1-6 illustrated in FIG. 2, respectively, and processing of procedures PR2-6 and PR2-7 are newly added. Hereinafter, the difference from the first embodiment will be described.

As illustrated in FIG. 7, the image processing apparatus 200 generates a guide image for correcting the transmittance map from at least one of the visible image I₁ and the infrared image I₂ (procedure PR2-6). Specifically, an image processing apparatus 20 generates the guide image by using the region of the visible image I₁ for the region where the first feature amount exceeds a first threshold value in the visible image I₁, and using the corresponding region of the infrared image I₂ for the region where the first feature amount does not exceed the first threshold value in the visible image I₁. Thus, the accuracy of correction of the transmittance map can be improved. Note that the first threshold value may be the same threshold value as the above-described first threshold value used when selecting the candidate image.

Further, the image processing apparatus 200 corrects the transmittance map on the basis of the generated guide image (procedure PR2-7). Further, the image processing apparatus 20 estimates a dehazed image obtained by removing the haze from the visible image I₁ using the corrected transmittance map (procedure PR2-8).

### 3-2. Apparatus Configuration Example

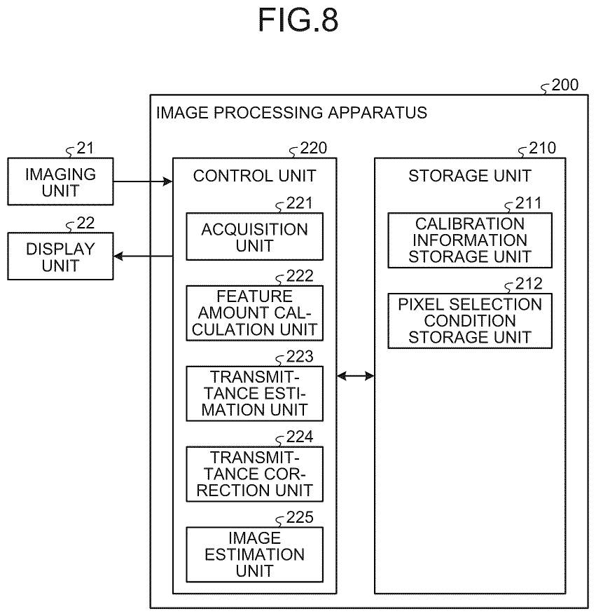

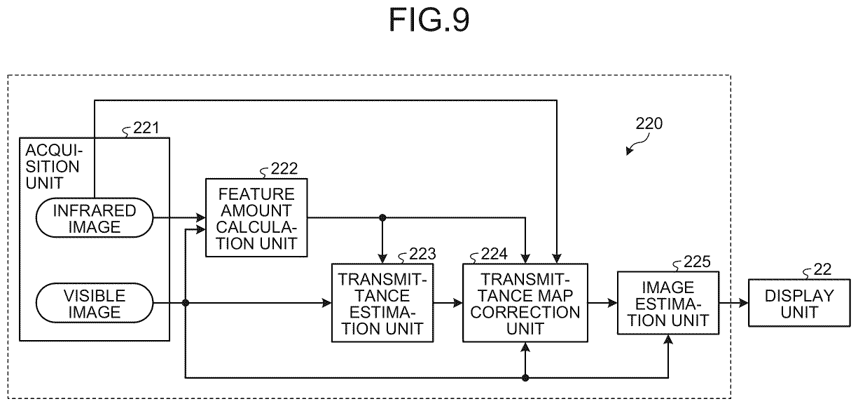

FIG. 8 is a block diagram illustrating a configuration example of the image processing apparatus according to the second embodiment of the present disclosure. With the image processing apparatus 200 according to the second embodiment, some of the processing functions included in a control unit 220 are different from those of the control unit 120 of the image processing apparatus 100 according to the first embodiment. That is, a calibration information storage unit 211 and a pixel selection condition storage unit 212 included in a storage unit 210 of the image processing apparatus 200 correspond to the calibration information storage unit 111 and the pixel selection condition storage unit 112 included in the storage unit 110 of the image processing apparatus 100. Further, in the control unit 220, a transmittance correction unit 224 illustrated in FIG. 8 is newly introduced as a new processing function not included in the control unit 120 of the image processing apparatus 100 according to the first embodiment. Hereinafter, a specific example of the control unit 220 will be described with reference to FIG. 9. FIG. 9 is an explanatory diagram for describing a specific example of the control unit according to the second embodiment of the present disclosure. Note that an acquisition unit 221, a feature amount calculation unit 222, and a transmittance estimation unit 223 included in the control unit 220 correspond to the acquisition unit 121, the feature amount calculation unit 122, and the transmittance estimation unit 123 included in the control unit 120 of the image processing apparatus 100, and thus, detailed description is omitted.

As illustrated in FIG. 9, the transmittance correction unit 224 corrects the transmittance map on the basis of the guide image generated from at least one of the visible image I₁ and the infrared image I₂. Specifically, the transmittance correction unit 224 generates the guide image by using the region of the visible image I₁ for the region where the first feature amount exceeds a first threshold value in the visible image I₁, and using the corresponding region of the infrared image I₂ for the region where the first feature amount does not exceed the first threshold value in the visible image I₁. The transmittance correction unit 224 corrects the transmittance map estimated by the transmittance estimation unit 223 on the basis of the generated guide image. The transmittance correction unit 224 passes the corrected transmittance map to an image estimation unit 225.

Note that the transmittance correction unit 224 may generate a guide image with reference to the transmittance map estimated by the transmittance estimation unit 223. Specifically, the transmittance correction unit 224 may generate the guide image by using the region of the visible image I₁ for the region where the transmittance exceeds a preset third threshold value (threshold value for evaluating the transmittance) in the visible image I₁, and using the corresponding region of the infrared image I₂ for the region where the transmittance is less than the third threshold value in the visible image I₁. Thus, the accuracy of correction of the transmittance map can be improved. The generation of the guide image using the transmittance map by the transmittance correction unit 224 can be expressed by Formula (10) described below. “I_{Guide}(x)” in Formula (10) represents a guide image.

I_{Guide}(x)=t(x)*Iᵥᵢₛ(x)+(1−t(x))*I_{NIR}(x) (10)

The image estimation unit 225 estimates the dehazed image using the transmittance map corrected by the transmittance correction unit 224. The image estimation unit 225 outputs the estimated dehazed image to a display unit 22.

### 3-3. Processing Procedure Example

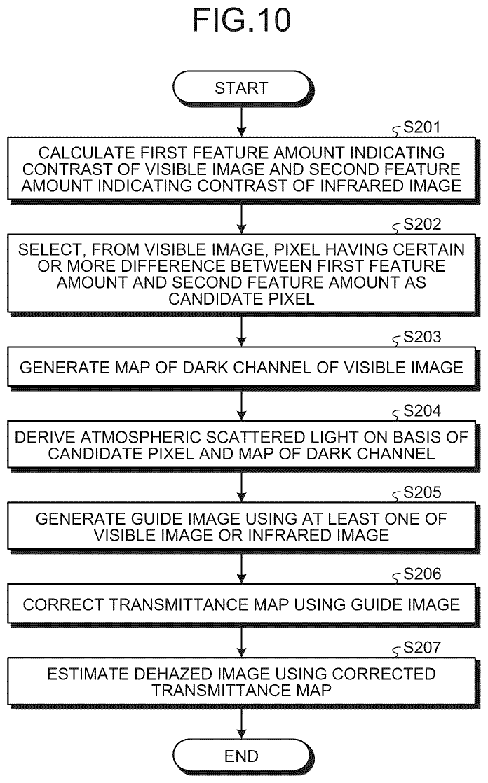

FIG. 10 is a flowchart illustrating an example of a processing procedure of the image processing apparatus according to the second embodiment of the present disclosure. The processing procedure illustrated in FIG. 10 is executed by the control unit 220 of the image processing apparatus 200. The processing procedure of the image processing apparatus 200 according to the second embodiment is basically similar to the processing procedure (see FIG. 6 and the like) of the image processing apparatus 100 according to the first embodiment, but the processing procedure after Step S205 illustrated in FIG. 10 is different from that of the first embodiment. Hereinafter, description of a processing procedure of Steps S201 to S204 similar to that of the first embodiment will be omitted, and differences from the first embodiment will be described.

That is, as illustrated in FIG. 10, the transmittance correction unit 224 generates a guide image for correcting the transmittance map using at least one of the visible image I₁ and the infrared image I₂ (Step S205).

Further, the transmittance correction unit 224 corrects the transmittance map using the guide image generated in Step S205 (Step S206).

Further, the image estimation unit 225 estimates a dehazed image obtained by removing the haze from the visible image I₁ using the corrected transmittance map corrected in Step S206 (Step S207) and ends the processing procedure illustrated in FIG. 10.

### 4. THIRD EMBODIMENT

### 4-1. Apparatus Configuration Example

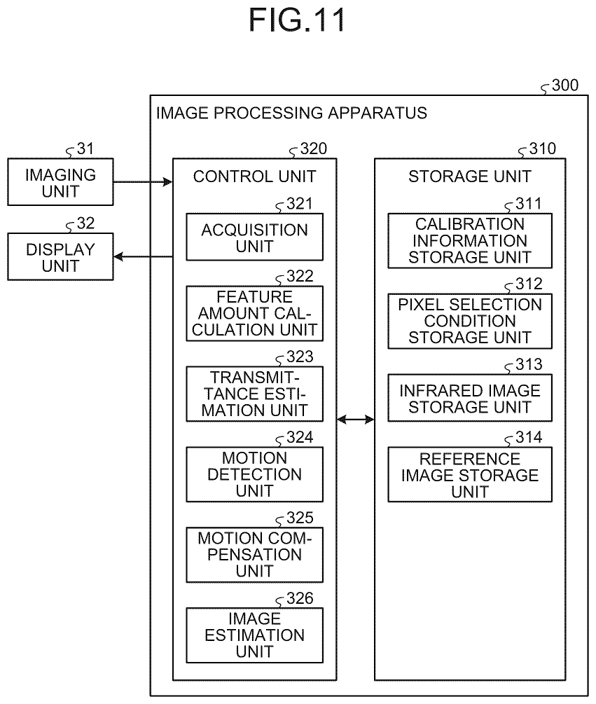

Hereinafter, an image processing apparatus 300 according to the third embodiment of the present disclosure will be described. The image processing apparatus 300 according to the third embodiment achieves cyclic dehazing processing for a moving image. FIG. 11 is a block diagram illustrating a configuration example of the image processing apparatus according to the third embodiment of the present disclosure.

As illustrated in FIG. 11, the image processing apparatus 300 is different from the image processing apparatus 100 according to the first embodiment in some information stored in a storage unit 310 and some of processing functions of a control unit 320. That is, the storage unit 310 newly includes an infrared image storage unit 313 and a reference image storage unit 314 illustrated in FIG. 11 in addition to a calibration information storage unit 311 and a pixel selection condition storage unit 312 corresponding to the calibration information storage unit 111 and the pixel selection condition storage unit 112. Further, the control unit 320 includes a motion detection unit 324 and a motion compensation unit 325 illustrated in FIG. 11 as new processing functions not included in the control unit 120 of the image processing apparatus 100 according to the first embodiment. Note that an acquisition unit 321, a feature amount calculation unit 322, and a transmittance estimation unit 323 included in the control unit 320 correspond to the acquisition unit 121, the feature amount calculation unit 122, and the transmittance estimation unit 123 included in the control unit 120, and thus, detailed description is omitted.

The infrared image storage unit 313 sequentially stores the infrared image 12 acquired by the acquisition unit 321. The reference image storage unit 314 stores the dehazed image estimated by an image estimation unit 326 as a reference image when the haze is removed from a next frame.

The motion detection unit 324 detects a motion vector by using a current frame of the infrared image I₂ and a previous frame of the infrared image I₂ one before (in the past) the current frame in time series. The motion detection unit 324 can detect a motion vector using a block matching method, a gradient method, or the like.

Using the motion vector detected by the motion detection unit 324, the motion compensation unit 325 acquires the processed dehazed image one before in time series from the reference image storage unit 314, and performs motion compensation in accordance with the motion of the pre-dehazing visible image I₁, which is a processing target, thereby generating a motion-compensated image.

The image estimation unit 326 uses a motion-compensated image (n) to estimate a dehazed visible image I₁(n) obtained by removing the haze of the pre-dehazing visible image I₁(n), which is a processing target.

### 4-2. Outline of Processing

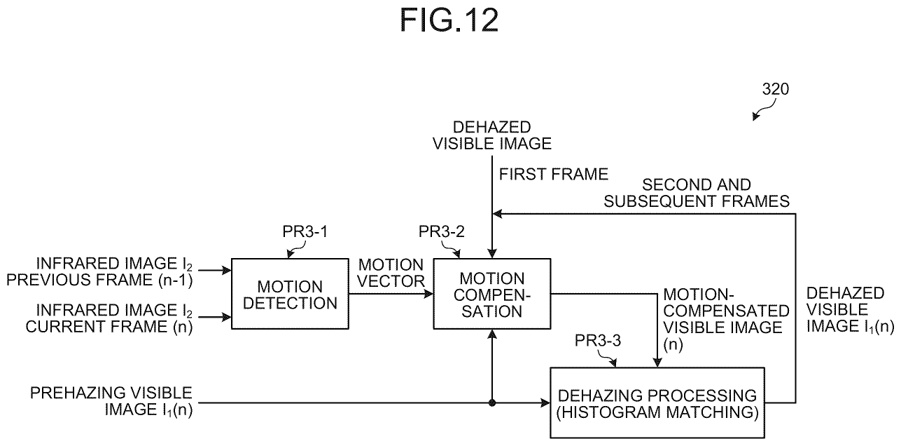

Hereinafter, an outline of processing of the image processing apparatus 300 according to the third embodiment will be described with reference to FIG. 12. FIG. 12 is a diagram illustrating an outline of processing according to the third embodiment of the present disclosure.

As illustrated in FIG. 12, when acquiring a current frame (n) of the infrared image I₂, the motion detection unit 324 acquires a previous frame (n−1) of the infrared image I₂ one before the current frame (n) in time series from the infrared image storage unit 313. Then, the motion detection unit 324 detects a motion vector by using the current frame (n) of the infrared image I₂ and the previous frame (n−1) of the infrared image I₂. Using a block matching method, a gradient method, or the like, the motion detection unit 324 can detect a motion vector indicating the motion (misalignment) of the subject shown in the current frame (n) and the previous frame (n−1) of the infrared image I₂.

Further, when acquiring the pre-dehazing visible image I₁(n), which is a processing target, the motion compensation unit 325 acquires the processed dehazed image (n−1) one before in time series from the reference image storage unit 314. Then, using the motion vector detected by the motion detection unit 324, the motion compensation unit 325 performs motion compensation on the dehazed image (n−1) in accordance with the motion of the pre-dehazing visible image I₁(n), which is a processing target, thereby generating a motion-compensated image (n). For example, the motion compensation unit 325 generates a motion-compensated image by transforming the processed dehazed image (n−1) one before in time series on the basis of the motion vector detected by the motion detection unit 324. Examples of the transformation method include simple parallel translation and nomography transformation. Note that, in a case where the processing target is the first frame of the moving image and the processed dehazed image is not stored in the reference image storage unit 314, the motion compensation unit 325 can use the visible image I₁ before occurrence of the haze as the reference image.

Further, when acquiring the pre-dehazing visible image I₁(n), which is a processing target, the image estimation unit 326 uses the motion-compensated image (n) generated by the motion compensation unit 325 to estimate a dehazed visible image I₁(n) obtained by removing the haze of the pre-dehazing visible image I₁(n), which is a processing target. For example, the image estimation unit 326 can estimate the dehazed visible image I₁(n) by the histogram matching method. Specifically, using the motion-compensated image (n) as a reference image, the image estimation unit 326 adjusts the brightness level of the pre-dehazing visible image I₁(n), which is a processing target, to the motion-compensated image (n) to be referred to, thereby estimating the dehazed visible image I₁(n).

Then, the image estimation unit 326 stores the dehazed visible image I₁(n) in the reference image storage unit 314 in order to use the dehazed visible image I₁(n) as a reference image for a pre-dehazing visible image I₁(n+1), which is a next processing target.

When acquiring the current frame (n+1) of the infrared image I₂, the motion detection unit 324 detects the motion vector as described above. Further, when acquiring the pre-dehazing visible image I₁(n+1), which is a processing target, the motion compensation unit 325 acquires the dehazed visible image I₁(n) from the reference image storage unit 314 as described above, and generates the motion-compensated image (n+1) obtained by performing motion compensation on the dehazed visible image I₁(n) using the motion vector detected by the motion detection unit 324. Further, when acquiring the pre-dehazing visible image Iᵢ(n+1), which is a processing target, the image estimation unit 326 uses the motion-compensated image (n+1) generated by the motion compensation unit 325 as a reference image to estimate a dehazed visible image I₁(n+1) obtained by removing the haze of the pre-dehazing visible image I₁(n+1), which is a processing target, and stores the dehazed visible image I₁(n+1) as a reference image in the reference image storage unit 314.

As described above, the motion detection unit 324, the motion compensation unit 325, and the image estimation unit 326 repeatedly execute the above-described processing each time a new frame of the visible image I₁, which is a processing target, is input. Thus, robust motion compensation can be performed for haze by using an infrared image, and a clear dehazed image can be efficiently obtained for a moving image.

### 5. OTHERS

A control program for achieving an image processing method executed by the image processing apparatus according to each embodiment of the present disclosure may be stored and distributed in a computer-readable recording medium such as an optical disk, a semiconductor memory, a magnetic tape, or a flexible disk. At this time, the image processing apparatus according to each of the embodiments and modifications of the present disclosure can achieve the image processing method according to the embodiments and the modifications of the present disclosure by installing and executing various programs on a computer.

Further, various programs for achieving the image processing method executed by the image processing apparatus according to each embodiment of the present disclosure may be stored in a disk apparatus included in a server on a network such as the Internet and may be downloaded to a computer. Further, functions provided by various programs for achieving the image processing method executed by the image processing apparatus according to each embodiment and modification of the present disclosure may be achieved by cooperation of the OS and an application program. In this case, a portion other than the OS may be stored in a medium and distributed, or a portion other than the OS may be stored in an application server and downloaded to a computer.

Further, at least a part of the processing function for achieving the image processing method executed by the image processing apparatus according to each embodiment of the present disclosure may be achieved by a cloud server on a network. For example, at least a part of the processing according to the first embodiment (FIG. 6 and the like), the processing according to the second embodiment (FIG. 10 and the like), and the processing according to the third embodiment (FIG. 12 and the like) may be executed on the cloud server.

Further, among the pieces of processing described in the embodiments of the present disclosure, all or some of the pieces of processing described as being performed automatically can be performed manually, or all or some of the pieces of processing described as being performed manually can be performed automatically by a known method. In addition, the processing procedures, the specific names, and the information including various data and parameters indicated in the above document and the drawings can be arbitrarily changed unless otherwise specified. For example, the various information illustrated in each drawing are not limited to the illustrated information.

Further, each component of the image processing apparatus according to each embodiment of the present disclosure is functionally conceptual, and does not necessarily need to be configured as illustrated in the drawings. For example, the motion detection unit 324 and the motion compensation unit 325 of the image processing apparatus 300 may be functionally integrated.

Further, the embodiments of the present disclosure can be appropriately combined insofar as the processing contents do not contradict. Further, the order of each step illustrated in the flowchart according to each embodiment of the present disclosure can be changed as appropriate.

Although the embodiments and modifications of the present disclosure have been described above, the technical scope of the present disclosure is not limited to the above-described embodiments, and various changes can be made without departing from the gist of the present disclosure. Further, components of different embodiments and modifications may be appropriately combined.

### 6. HARDWARE CONFIGURATION EXAMPLE

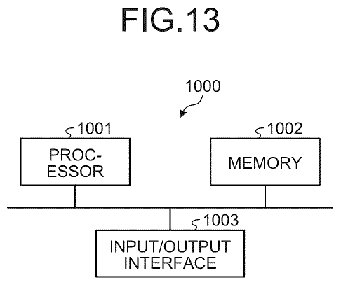

A hardware configuration example of a computer corresponding to the image processing apparatus according to each embodiment of the present disclosure will be described with reference to FIG. 13. FIG. 13 is a hardware configuration diagram illustrating an example of a computer that achieves the functions of the image processing apparatus according to each embodiment of the present disclosure. Note that FIG. 13 illustrates an example of a hardware configuration of a computer corresponding to the image processing apparatus according to each embodiment of the present disclosure, and the configuration is not necessarily limited to the configuration illustrated in FIG. 13.

As illustrated in FIG. 13, a computer 1000 that achieves the functions of the image processing apparatus according to each embodiment of the present disclosure includes a processor 1001, a memory 1002, and an input/output interface 1003.

The processor 1001 is typically a central processing unit (CPU), a digital signal processor (DSP), a system-on-a-chip (SoC), a system large scale integration (LSI), or the like. The processor 1001 functions as an arithmetic processing apparatus or a control apparatus of the image processing apparatus (100, 200, and 300) according to each embodiment.

The memory 1002 is typically a nonvolatile or volatile semiconductor memory such as random access memory (RAM), read only memory (ROM), or flash memory, or a magnetic disk. The storage unit 110 included in the image processing apparatus 100, the storage unit 210 included in the image processing apparatus 200, and the storage unit 310 included in the image processing apparatus 300 are achieved by the memory 1002.

The input/output interface 1003 connects an input/output device and the computer 1000. For example, the processor 1001 receives the image data acquired by the imaging unit 11 via the input/output interface 1003. Further, for example, the processor 1001 transmits image data to the display unit 12 via the input/output interface 1003. Further, the input/output interface 1003 may function as a media interface that reads a program or the like recorded in a predetermined recording medium (media). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

In a case where the computer 1000 achieves the functions of the image processing apparatus (100, 200, and 300) according to each embodiment, the processor 1001 controls the entire or partial operation of each component on the basis of various programs recorded in the memory 1002. For example, the functions of the acquisition unit 121, the feature amount calculation unit 122, the transmittance estimation unit 223, the image estimation unit 124, and the like, which are the components included in the control unit 120 of the image processing apparatus 100, are achieved by the processor 1001 reading an image processing program in which a command for operating as each component is described from the memory 1002 and executing the image processing program.

That is, the processor 1001 and the memory 1002 achieve a processing function by the image processing apparatus according to each embodiment in cooperation with software (such as the image processing program stored in the memory 1002).

### 7. CONCLUSION

The image processing apparatus (100, 200, and 300) according to each embodiment of the present disclosure includes the image estimation unit (124, 225, and 326). The image estimation unit estimates a removal image obtained by removing, from the visible image, a scatter component of sunlight scattered when passing through the atmospheric layer, on the basis of the visible image and the infrared image captured simultaneously. Thus, a clear dehazed image can be obtained without being affected by the configuration of the subject.

Further, the image processing apparatus further includes the feature amount calculation unit (122, 222, and 322) and the transmittance estimation unit (123, 223, and 323). The feature amount calculation unit calculates the first feature amount indicating the contrast of the visible image for each local region of the visible image and the second feature amount indicating the contrast of the infrared image for each local region of the infrared image. The transmittance estimation unit selects a pixel having a predetermined or more difference between the first feature amount and the second feature amount from the visible image as a candidate pixel to be used for calculation of the scatter component, and estimates a transmittance map indicating a degree of scattering of the sunlight in the visible image using, as the scatter component, RGB values of a pixel also corresponding to pixels having a higher brightness value in a dark channel of the visible image among the selected candidate pixels. The image estimation unit estimates the removal image using the transmittance map estimated by the transmittance estimation unit. Thus, pixels erroneously estimated as atmospheric scattered light can be excluded from the pixels included in the dark channel, and the estimation accuracy of the transmittance can be improved.

Further, the transmittance estimation unit selects, as a candidate pixel, a pixel among the pixels of the visible image the first feature amount of which is less than the preset first threshold value and the second feature amount of which exceeds the preset second threshold value in the infrared image. Thus, it is possible to select an optimal pixel for deriving atmospheric scattered light.

Further, the feature amount calculation unit calculates the first feature amount using a component value of the R channel, the G channel, or the B channel included in the visible image. Thus, it is easy to compare the contrasts of the visible image and the infrared image.

Further, the feature amount calculation unit calculates the first feature amount by using an average value of the component values of the R channel, the G channel, and the B channel included in the visible image. Thus, it is possible to evaluate the contrast while suppressing the influence of an outstanding value included in each color channel of the visible image.

Further, the image processing apparatus (200) further includes the transmittance correction unit (224). The transmittance correction unit corrects the transmittance map estimated by the transmittance estimation unit on the basis of the guide image generated from at least one of the visible image and the infrared image. Thus, the accuracy of the transmittance map can be improved.

Further, the transmittance correction unit generates the guide image by using the region of the visible image for the region where the first feature amount exceeds the first threshold value in the visible image, and using the corresponding region of the infrared image for the region where the first feature amount does not exceed the first threshold value in the visible image. Thus, the accuracy of correction of the transmittance map can be improved.

Further, the transmittance correction unit refers to the transmittance map, and generates the guide image by using the region of the visible image for the region where the transmittance exceeds the preset third threshold value in the visible image, and using the corresponding region of the infrared image for the region where the transmittance is less than the third threshold value in the visible image. Thus, the accuracy of correction of the transmittance map can be improved.

Further, the image processing apparatus (300) further includes the motion detection unit (324) and the motion compensation unit (325). The motion detection unit detects a motion vector by using a current frame of the infrared image and a previous frame of the infrared image one before the current frame in time series. Using the motion vector detected by the motion detection unit, the motion compensation unit generates a motion-compensated image obtained by performing motion compensation on the removal image one before in time series in accordance with the motion of the visible image, which is a processing target. The image estimation unit generates a removal image by using the motion-compensated image and the visible image, which is a processing target. Thus, robust motion compensation can be performed for haze by using an infrared image, and a clear dehazed image can be efficiently obtained for a moving image.

Note that the effects described in the present specification are merely illustrative or exemplary and are not limiting. That is, the technique of the present disclosure can have other effects apparent to those skilled in the art from the description of the present specification, in addition to or instead of the above effects.

Note that the technique of the present disclosure can also have the configurations described below as belonging to the technical scope of the present disclosure.

(1)

An image processing apparatus including:
an image estimation unit that estimates a removal image obtained by removing, from a visible image, a scatter component of sunlight scattered when passing through an atmospheric layer, on a basis of the visible image and an infrared image captured simultaneously with the visible image.
   (2)

The image processing apparatus according to (1), further including:
a feature amount calculation unit that calculates a first feature amount indicating contrast of the visible image for each local region of the visible image and a second feature amount indicating contrast of the infrared image for each local region of the infrared image; and
a transmittance estimation unit that selects a pixel having a predetermined or more difference between the first feature amount and the second feature amount from the visible image as a candidate pixel to be used for calculation of the scatter component, and estimates a transmittance map indicating a degree of scattering of the sunlight in the visible image by using, as the scatter component, RGB values of a pixel also corresponding to a pixel having a higher brightness value in a dark channel of the visible image among the selected candidate pixels,
wherein the image estimation unit estimates the removal image using the transmittance map estimated by the transmittance estimation unit.
   (3)

The image processing apparatus according to (2),
wherein the transmittance estimation unit
selects, as the candidate pixel, a pixel among pixels of the visible image the first feature amount of which is less than a preset first threshold value and the second feature amount of which exceeds a preset second threshold value in the infrared image.
   (4)

The image processing apparatus according to (2) or (3),
wherein the feature amount calculation unit
calculates the first feature amount using a component value of an R channel, a G channel, or a B channel included in the visible image.
   (5)

The image processing apparatus according to (2) or (3),
wherein the feature amount calculation unit
calculates the first feature amount by using an average value of component values of an R channel, a G channel, and a B channel included in the visible image.
   (6)

The image processing apparatus according to any one of (2) to (5), further including:
a transmittance correction unit that corrects the transmittance map estimated by the transmittance estimation unit on a basis of a guide image generated from at least one of the visible image and the infrared image.
   (7)

The image processing apparatus according to (6),
wherein the transmittance correction unit
generates the guide image by using a region of the visible image for a region where the first feature amount exceeds a first threshold value in the visible image, and using a corresponding region of the infrared image for a region where the first feature amount does not exceed the first threshold value in the visible image.
   (8)

The image processing apparatus according to (6),
wherein the transmittance correction unit
refers to the transmittance map, and generates the guide image by using a region of the visible image for a region where transmittance exceeds a preset third threshold value in the visible image, and using a corresponding region of the infrared image for a region where transmittance does not exceed the third threshold value in the visible image.
   (9)

The image processing apparatus according to (1), further including:
a motion detection unit that detects a motion vector by using a current frame of the infrared image and a previous frame of the infrared image one before the current frame in time series; and
a motion compensation unit that generates, using the motion vector detected by the motion detection unit, a motion-compensated image obtained by performing motion compensation on the removal image one before in time series in accordance with motion of the visible image, which is a processing target,
wherein the image estimation unit
generates the removal image by using the motion-compensated image and the visible image, which is a processing target.
   (10)

An image processing method including:
estimating a removal image obtained by removing, from a visible image, a scatter component of sunlight scattered when passing through an atmospheric layer, on a basis of the visible image and an infrared image captured simultaneously with the visible image.

### REFERENCE SIGNS LIST

11 IMAGING UNIT
12 DISPLAY UNIT
100 IMAGE PROCESSING APPARATUS
110 STORAGE UNIT
111 CALIBRATION INFORMATION STORAGE UNIT
112 PIXEL SELECTION CONDITION STORAGE UNIT
120 CONTROL UNIT
121 ACQUISITION UNIT
122 FEATURE AMOUNT CALCULATION UNIT
123 TRANSMITTANCE ESTIMATION UNIT
124 IMAGE ESTIMATION UNIT
200 IMAGE PROCESSING APPARATUS
210 STORAGE UNIT
211 CALIBRATION INFORMATION STORAGE UNIT
212 PIXEL SELECTION CONDITION STORAGE UNIT
220 CONTROL UNIT
221 ACQUISITION UNIT
222 FEATURE AMOUNT CALCULATION UNIT
223 TRANSMITTANCE ESTIMATION UNIT
224 TRANSMITTANCE CORRECTION UNIT
225 IMAGE ESTIMATION UNIT
300 IMAGE PROCESSING APPARATUS
310 STORAGE UNIT
311 CALIBRATION INFORMATION STORAGE UNIT
312 PIXEL SELECTION CONDITION STORAGE UNIT
313 INFRARED IMAGE STORAGE UNIT
314 REFERENCE IMAGE STORAGE UNIT
320 CONTROL UNIT
321 ACQUISITION UNIT
322 FEATURE AMOUNT CALCULATION UNIT
323 TRANSMITTANCE ESTIMATION UNIT
324 MOTION DETECTION UNIT
325 MOTION COMPENSATION UNIT
326 IMAGE ESTIMATION UNIT
1000 COMPUTER
1001 PROCESSOR
1002 MEMORY
1003 INPUT/OUTPUT INTERFACE

1. An image processing apparatus including:
an image estimation unit that estimates a removal image obtained by removing, from a visible image, a scatter component of sunlight scattered when passing through an atmospheric layer, on a basis of the visible image and an infrared image captured simultaneously with the visible image.

2. The image processing apparatus according to claim 1, further including:
a feature amount calculation unit that calculates a first feature amount indicating contrast of the visible image for each local region of the visible image and a second feature amount indicating contrast of the infrared image for each local region of the infrared image; and
a transmittance estimation unit that selects a pixel having a predetermined or more difference between the first feature amount and the second feature amount from the visible image as a candidate pixel to be used for calculation of the scatter component, and estimates a transmittance map indicating a degree of scattering of the sunlight in the visible image by using, as the scatter component, RGB values of a pixel also corresponding to a pixel having a higher brightness value in a dark channel of the visible image among the selected candidate pixels,
wherein the image estimation unit estimates the removal image using the transmittance map estimated by the transmittance estimation unit.

3. The image processing apparatus according to claim 2,
wherein the transmittance estimation unit
selects, as the candidate pixel, a pixel among pixels of the visible image the first feature amount of which is less than a preset first threshold value and the second feature amount of which exceeds a preset second threshold value in the infrared image.

4. The image processing apparatus according to claim 2,
wherein the feature amount calculation unit
calculates the first feature amount using a component value of an R channel, a G channel, or a B channel included in the visible image.

5. The image processing apparatus according to claim 2,
wherein the feature amount calculation unit
calculates the first feature amount by using an average value of component values of an R channel, a G channel, and a B channel included in the visible image.

6. The image processing apparatus according to claim 2, further including:
a transmittance correction unit that corrects the transmittance map estimated by the transmittance estimation unit on a basis of a guide image generated from at least one of the visible image and the infrared image.

7. The image processing apparatus according to claim 6,
wherein the transmittance correction unit
generates the guide image by using a region of the visible image for a region where the first feature amount exceeds a first threshold value in the visible image, and using a corresponding region of the infrared image for a region where the first feature amount does not exceed the first threshold value in the visible image.

8. The image processing apparatus according to claim 6,
wherein the transmittance correction unit
refers to the transmittance map, and generates the guide image by using a region of the visible image for a region where transmittance exceeds a preset third threshold value in the visible image, and using a corresponding region of the infrared image for a region where transmittance does not exceed the third threshold value in the visible image.

9. The image processing apparatus according to claim 1, further including:
a motion detection unit that detects a motion vector by using a current frame of the infrared image and a previous frame of the infrared image one before the current frame in time series; and
a motion compensation unit that generates, using the motion vector detected by the motion detection unit, a motion-compensated image obtained by performing motion compensation on the removal image one before in time series in accordance with motion of the visible image, which is a processing target,
wherein the image estimation unit
generates the removal image by using the motion-compensated image and the visible image, which is a processing target.

10. An image processing method including:
estimating a removal image obtained by removing, from a visible image, a scatter component of sunlight scattered when passing through an atmospheric layer, on a basis of the visible image and an infrared image captured simultaneously with the visible image.
